(19) United States
(12) Patent Application Publication
(10) Pub. No.: US 2024/0427933 A1
(43) Pub. Date: Dec. 26, 2024

(54) MAINTENANCE DATA SANITIZATION

(71) Applicant: Schneider Electric USA, Inc., Andover, MA (US)

(72) Inventors: Imran Khan, Grenoble (FR); Hicham Hossayni, Grenoble (FR); Noel Crespi, Vernon (FR)

(73) Assignee: Schneider Electric USA, Inc., Boston, MA (US)

(21) Appl. No.: 18/697,043

(22) PCT Filed: Sep. 30, 2022
(86) PCT No.: PCT/US2022/045406

§ 371 Date: Mar. 29, 2024

Related U.S. Application Data
(60) Provisional application No. 63/251,362, filed on Oct. 1, 2021.

(51) Int. Cl. G06F 21/62; G06F 40/295; G06N 20/00

(52) U.S. Cl. CPC G06F 21/6254; G06F 40/295; G06N 20/00

(57) ABSTRACT

Embodiments described herein provide techniques for managing sensitive data within maintenance reports. A first maintenance report comprising an instance of text data describing a maintenance event for a first physical apparatus is retrieved and is processed using a trained Named Entity Recognition model to identify instances of one or more words that are associated with a respective real-world name(s). Embodiments determine whether a first identified instance of one or more words represents sensitive data, using a data anonymization rules ontology that describes a plurality of different ways to identify sensitive data within maintenance reports. If the first maintenance report is determined to include sensitive data, the first maintenance report is flagged as a potentially sensitive maintenance report that requires further review. If the first maintenance report is determined to not include any sensitive data, the first maintenance report is added to a plurality of maintenance reports to be externally released.

### TECHNICAL FIELD

The present disclosure relates to machine learning, and more particularly, to techniques for building a machine learning model and using such a model for dynamically processing a corpus of maintenance reports to identify reports potentially containing sensitive information.

### BACKGROUND

Machine learning and artificial intelligence are quickly transforming the technical landscape and are allowing us to make determinations and optimizations in equipment, processes and other areas that were never practical and sometimes never possible before. However, to construct a machine learning model to solve a particular problem, a significant amount of training data is often required to train the machine learning model on the problem.

### SUMMARY

One embodiment provides a method that includes retrieving a first maintenance report comprising an instance of text data describing a maintenance event for a first physical apparatus. The method also includes processing, by operation of one or more computer processors, the first maintenance report using a trained Named Entity Recognition (NER) model to identify instances of one or more words that are associated with a respective real-world name. The method further includes determining whether a first identified instance of one or more words represents sensitive data, using a data anonymization rules ontology that describes a plurality of different ways to identify sensitive data within maintenance reports. Additionally, the method includes, if the first maintenance report is determined to include sensitive data, determining whether the first maintenance report can be automatically modified with a first modification, such that the modified first maintenance report does not include any sensitive data, using on the data anonymization rules ontology and if so, performing, by operation of the one or more computer processors, the first modification on the first maintenance report and adding the modified first maintenance report to a plurality of maintenance reports to be externally released. The method also includes, if it is determined that the first maintenance report cannot be automatically modified with the first modification, flagging the first maintenance report as a potentially sensitive maintenance report that requires further review. The method includes, if the first maintenance report is determined to not include any sensitive data, adding the first maintenance report to the plurality of maintenance reports to be externally released.

Another embodiment provides a system that includes retrieving a first maintenance report comprising an instance of text data describing a maintenance event for a first physical apparatus. The system also includes processing the first maintenance report using a trained NER model to identify instances of one or more words that are associated with a respective real-world name. Additionally, the system includes determining whether a first identified instance of one or more words represents sensitive data, using a data anonymization rules ontology that describes a plurality of different ways to identify sensitive data within maintenance reports. The system further includes, if the first maintenance report is determined to include sensitive data, flagging the first maintenance report as a potentially sensitive maintenance report that requires further review; if the first maintenance report is determined to not include any sensitive data, adding the first maintenance report to a plurality of maintenance reports to be externally released.

Another embodiment provides a non-transitory computer readable medium containing computer program code that, when executed by operation of one or more computer processors, performs an operation. The operation comprises retrieving a first maintenance report comprising an instance of text data describing a maintenance event for a first physical apparatus. The first maintenance report comprises (a) a first section containing structured text data describing attributes of the maintenance event and (b) a second section containing unstructured text data written by a maintenance operator describing the maintenance event. The operation further includes processing the first maintenance report using a trained NER model to identify instances of one or more words that are associated with a respective real-world name. Additionally, the operation includes determining whether a first identified instance of one or more words represents sensitive data, using a data anonymization rules ontology that describes a plurality of different ways to identify sensitive data within maintenance reports, including identifying one or more text portions within the first maintenance report that correspond to one or more machine components, and determining, for each of the one or more machine components, whether the respective machine component is classified as a sensitive machine component, using the trained NER model, one or more data sensitivity rules, and one or more rule-based resources. The operation also includes, upon determining that the first maintenance report includes sensitive data, flagging the first maintenance report as a potentially sensitive maintenance report that requires further review, receiving one or more redactions to the first maintenance report from a reviewer, the one or more redactions modifying or deleting one or more text characters from the first maintenance report, processing the first maintenance report to incorporate the one or more redactions, and adding the processed first maintenance report to a plurality of maintenance reports to be externally released.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

Identical reference numerals have been used, where possible, to designate identical elements that are common to the figures. However, elements disclosed in one embodiment may be beneficially utilized on other embodiments without specific recitation.

FIG. 1 is a block diagram illustrating a system configured with a maintenance report sanitization system, according to one embodiment described herein.

FIG. 2 is a block diagram illustrating a system for training and deploying a maintenance report sanitization component, according to one embodiment described herein.

FIG. 3 is a flow diagram illustrating a method for processing maintenance reports to sanitize the maintenance reports for external release, according to one embodiment described herein.

FIG. 4 is a flow diagram illustrating a method for processing maintenance reports to identify and manage any sensitive data contained within the maintenance reports, according to one embodiment described herein.

FIG. 5 is a flow diagram illustrating a method for processing a maintenance report to be included in a corpus of maintenance reports intended for external release, according to one embodiment described herein.

FIG. 6 is a flow diagram illustrating a workflow for processing maintenance reports to identify sensitive reports, according to one embodiment described herein.

### DETAILED DESCRIPTION

Generally, to construct a machine learning model to solve a particular problem, a significant amount of training data is often required to train the machine learning model on the problem. While this may be less burdensome with purely internal projects (e.g., where a business entity may have significant amounts of data on their own products and equipment), it can be difficult to amass a significant amount of training data when constructing machine learning models that target a problem that exists across multiple business entities or even across an entire industry. That is, because certain documents involved in training the machine learning model may include potentially sensitive data for a given business entity, the business entity may be reluctant to share their documents at all, as conducting a precise review of all of their documents to identify sensitive information is frequently impractical.

Automating the review of the documents to identify sensitive information is one option for solving the aforementioned problem. However, a technical challenge exists in finding a technical solution to automate the document in review to identify sensitive data in a manner that is sufficiently robust, efficient and accurate. In one embodiment, accuracy (i.e., ensuring that documents containing sensitive data are identified as sensitive, even if some documents not containing sensitive data are falsely identified as sensitive) is a primary concern, as the release of any documents containing sensitive information can be problematic for a business entity and the risk of such a release may stop the business entity from releasing their documents altogether. However, it is desirable for businesses and other organizations to share such documents with one another and with the community at large, as doing so allows them to take benefit of the previous experiences of others during the maintenance of similar types of machines and common failures. It also enables the training of a plethora of machine learning models that can help solve many problems and produce many optimizations across the business and across the industry as a whole. Thus, by releasing sanitized reports externally, organizations can help to improve the maintenance activity in other plants and factories where same type of machines exists and can help operators benefits from the data of others to solve similar issues.

As such, one embodiment provides a method that includes retrieving a first maintenance report comprising an instance of text data describing a maintenance event for a first physical apparatus. For example, the first maintenance report could relate to a particular piece of physical equipment produced by a manufacturer and could describe a discrete maintenance event that occurred for the particular piece of physical equipment. In one embodiment, the first maintenance report includes both structured and unstructured text. For example, the first maintenance report could include a section including blank spaces where a maintenance technician can fill in information relating to various attributes of the maintenance event (e.g., the identifier of the equipment involved in the event, the time and date the event occurred, a specific part number involved in the maintenance event, a name of the technician(s) working on the maintenance event, etc.). Such a report could also contain a section designated for unstructured text, such as a free text field where a maintenance engineer can write a narrative describing the maintenance event, what occurred and what was done to rectify the event.

The method includes processing, by operation of one or more computer processors, the first maintenance report using a trained Named Entity Recognition (NER) model to identify instances of one or more words that are associated with a respective one or more real-world names. For example, such a NER model could be trained using a specific machine ontology that describes the particular piece of physical equipment that is the involved of the maintenance report, along with an annotated corpus of maintenance reports that contains numerous text entries together with tagged machine components. In such an example, the tagged machine components can all be part of a machine taxonomy that brings together the components' names, their synonyms and abbreviations used to refer to them. Likewise, the specific machine ontology could refer only to components referenced in the machine components taxonomy, thereby guaranteeing the synchronization between the components identified by the NER model and the components referenced in the machine ontology.

The method further includes determining whether a first identified instance of one or more words represents sensitive data, using a data anonymization rules ontology that describes a plurality of different ways to identify sensitive data within maintenance reports. Such a data anonymization rules ontology could be constructed using a plurality of data sensitivity rules (e.g., which may be generated by a domain expert for the organization producing the maintenance reports), as well as rule-based resources which may include patterns, dictionaries, and so on. The data anonymization rules ontology may be referenced (e.g., imported) in the specific machine ontology to allow domain experts to specify the sensitivity rules or flags for each machine component. For example, the domain experts may define a component within the specific machine ontology as potentially sensitive or not sensitive. The data anonymization rules ontology may also reference the rule-based resources (e.g., a particular dictionary object) that are used during the sensitive data search phase.

The method also includes, if the first maintenance report is determined to include sensitive data, flagging the first maintenance report as a potentially sensitive maintenance report that requires further review. Moreover, if the first maintenance report is determined to not include any sensitive data, the method includes adding the first maintenance report to a plurality of maintenance reports to be externally released. Advantageously, doing so allows the automated review of maintenance reports to identify reports containing potentially sensitive information in an accurate and efficient manner, thereby allowing the sanitized maintenance reports (e.g., the maintenance reports determined not to contain sensitive information, as well as redacted forms of the maintenance reports determined to contain sensitive information) to be released for use in training other machine learning models and various other such projects.

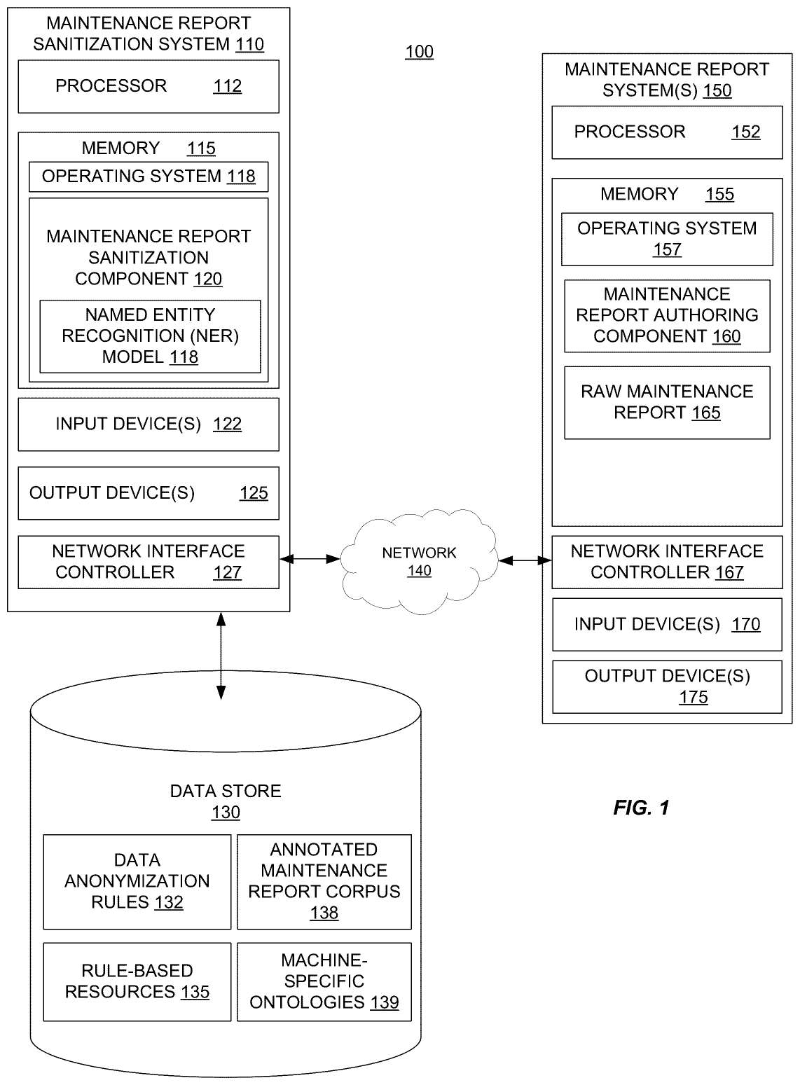

FIG. 1 is a block diagram illustrating a system configured with a maintenance report sanitization system, according to one embodiment described herein. As shown, the system 100 includes a maintenance report sanitization system 110 and a maintenance report system(s) 150, interconnected via a network 140. The maintenance report sanitization system 110 includes a processor 112, a memory 115, one or more input devices 122, one or more output devices 125 and a network interface controller 127. The memory includes an operating system 118 and a maintenance report sanitization component 120, which in turn includes a Named Entity Recognition (NER) model 118.

The maintenance report system(s) 150 includes a processor 152, a memory 155, a network interface controller 167, an input device(s) 170, and an output device(s) 175. The memory 155 contains an operating system 157, a maintenance report authoring component 160 and an instance of a raw maintenance report 165. Generally, the maintenance report authoring component 160 represents software logic through which maintenance engineers can generate the raw maintenance report 165. As discussed above, the raw maintenance report 165 may describe a discrete maintenance event that occurred on a particular piece of physical equipment. Moreover, the raw maintenance report 165 could include both structured and unstructured text data.

Additionally, the maintenance report sanitization system 110 is communicatively coupled to a data store 130. In the depicted embodiment, the data store 130 includes data anonymization rules 132, rule-based resources 135, an annotated maintenance report corpus 138 and machine-specific ontologies 139. While the data store 130 is shown as a single entity, such a depiction is for illustrative purposes only and without limitation. More generally, any suitable number and type of data store can be used for storing the depicted information. While the various types of information (e.g., data anonymization rules 132, rule-based resources 135, etc.) may be stored together, it is consider that the various types of information may also be stored on separate data stores and need not be stored together.

Generally, the data anonymization rules 132 are used to define what information should be considered sensitive as opposed to what is considered not sensitive. In one embodiment, the data anonymization rules 132 are constructed by a domain expert(s) for the organization. The machine-specific ontologies 139 each relate to a particular machine or other physical apparatus. For example, a first machine-specific ontology 139 could relate to a particular model of a product and could contain a description of the particular product model as well as its components. The rule-based resources 135 represent patterns, dictionaries, etc., that can be used by the data anonymization rules 132.

For example, a first data anonymization rule 132 could specify that product serial numbers are potentially sensitive information and could reference a first rule-based resource 135 that specifies a pattern that serial numbers for a particular type of equipment are known to follow. As an example, the pattern could specify that the serial numbers begin with a 4-character year, followed by the characters “ID”, and then followed by a unique 6-character identifier. When evaluating whether a given maintenance report satisfies the first data anonymization rule 132, the maintenance report sanitization component 120 could determine whether any text within the maintenance report satisfies the corresponding first rule-based resource 135 and if so, could classify the maintenance report as potentially sensitive; if not, the maintenance report sanitization component 120 could continue to evaluate any other applicable rules in the data anonymization rules 132 before classifying the maintenance report as not containing sensitive information.

The annotated maintenance report corpus 138 represents a set of maintenance reports that have been annotated by domain experts or other suitable users. In one embodiment, the annotated maintenance report corpus 138 have been annotated to identify components within the reports that are potentially constitute sensitive information. For example, such components could include part numbers, machine components and systems, and generally any elements that are part of a machine taxonomy for one or more pieces of equipment.

Generally, the machine-specific ontologies 139 generally define relationships between machine components. In one embodiment, the machine-specific ontologies 139 refer only to components defined in a machine components taxonomy. In such an embodiment, the annotated maintenance report corpus 138 could only include annotations for components within one or more of the machine-specific ontologies 139. For example, the machine components taxonomy could be defined for a particular line of equipment, and the machine-specific ontologies 139 could define relationships between machine components of various models of equipment within the particular line of equipment.

The maintenance report sanitization component 120 can use the annotated maintenance report corpus 138 and the machine-specific ontologies 139 to train the NER model 118. Generally, the NER model 118 can be configured to recognize text within a maintenance report that relates to a potentially sensitive component. The maintenance report sanitization component 120 could then use the NER model 118 to identify instances of text within maintenance reports that refer to potentially sensitive components (and thus the maintenance report potentially contains sensitive information). For example, the raw maintenance report 165 could be generated on the maintenance report system(s) 150 and transmitted to the maintenance report sanitization component 120 via the network 140. As another example, a raw maintenance report could be completed on one or more physical pieces of paper, and an electronic copy of the maintenance report could be created, e.g., by scanning the one or more physical pieces of paper using any suitable scanning devices and by processing the scanned image using, for example, one or more Optical Character Recognition (OCR) techniques. More generally, it is contemplated the maintenance report sanitization component 120 can receive maintenance reports from any number of different sources and can process these maintenance reports to detect potentially sensitive information within the reports, consistent with the functionality described herein.

The maintenance report sanitization component 120 could then use the data anonymization rules 132 and any corresponding rule-based resources 135 to determine a likelihood that an identified instance of text contains sensitive information. As an example, a reference to a particular machine component may be deemed as constituting sensitive information in certain contexts, but in more general uses may be deemed as not constitute sensitive information. In such a case, the NER model 118 could be trained to identify any and all references to the particular machine component within maintenance reports, and the data anonymization rules 132 and the corresponding rule-based resources 135 can be configured to determine whether a given reference to the particular machine component constitutes sensitive information. Doing so allows the determination regarding sensitive information to be tailored to a specific environment through the creation and modification of the data anonymization rules 132 and the corresponding rule-based resources 135. Moreover, doing so improves the efficiency of the system by avoiding processing references to components that have never been indicated as constituting sensitive information (i.e., no references to such components were included in the annotations of the annotated maintenance report corpus 138).

If the maintenance report sanitization component 120 determines that the raw maintenance report 165 does likely contain sensitive information (e.g., text within the report satisfies as least one of the data anonymization rules 132), the maintenance report sanitization component 120 could determine whether the satisfied rule(s) (or another suitable structure) specifies an automatic modification to be performed to sanitize the maintenance report. For example, a first data anonymization rule 132 configured to detect product serial numbers could specify a modification to genericize the text containing the serial number within a maintenance report (e.g., replacing the text satisfying the rule with a predefined phrase, such as SERIAL_NUMBER_1, etc.).

As another example, a second data anonymization rule 132 configured to detect references to machine components could specify a modification to redact the text containing the reference from the maintenance report (e.g., deleting the text entirely from the report, applying a modification to the maintenance report to cover up the text, etc.). More generally, it is contemplated that any suitable modification could be specified to automatically process and sanitize the maintenance report, consistent with the functionality described herein. To this end, the corresponding modification for a particular data anonymization rule 132 may not be defined within the rules themselves, but more generally it is contemplated that such a modification could be defined separately within the data store 130, within the memory 115, as part of the maintenance report sanitization component 120 or more generally in any other suitable location or as part of any other suitable component, consistent with the functionality described herein. As such, the examples provided herein are for illustrative purposes only and are without limitation.

If the maintenance report sanitization component 120 determines the maintenance report cannot be automatically modified, the maintenance report sanitization component 120 could flag the maintenance report as requiring further review. A user could then manually review the flagged maintenance report could determine how the report should be handled, e.g., whether the report should not be released at all, whether the report should be modified to remove the reference(s) to sensitive information, or whether the report constitutes a false positive and was mistakenly flagged as containing sensitive information. In one embodiment, the maintenance report sanitization component 120 can incorporate the user feedback into the NER model 118 and/or the data anonymization rules 132 as part of a feedback loop to optimize the maintenance report sanitization component 120.

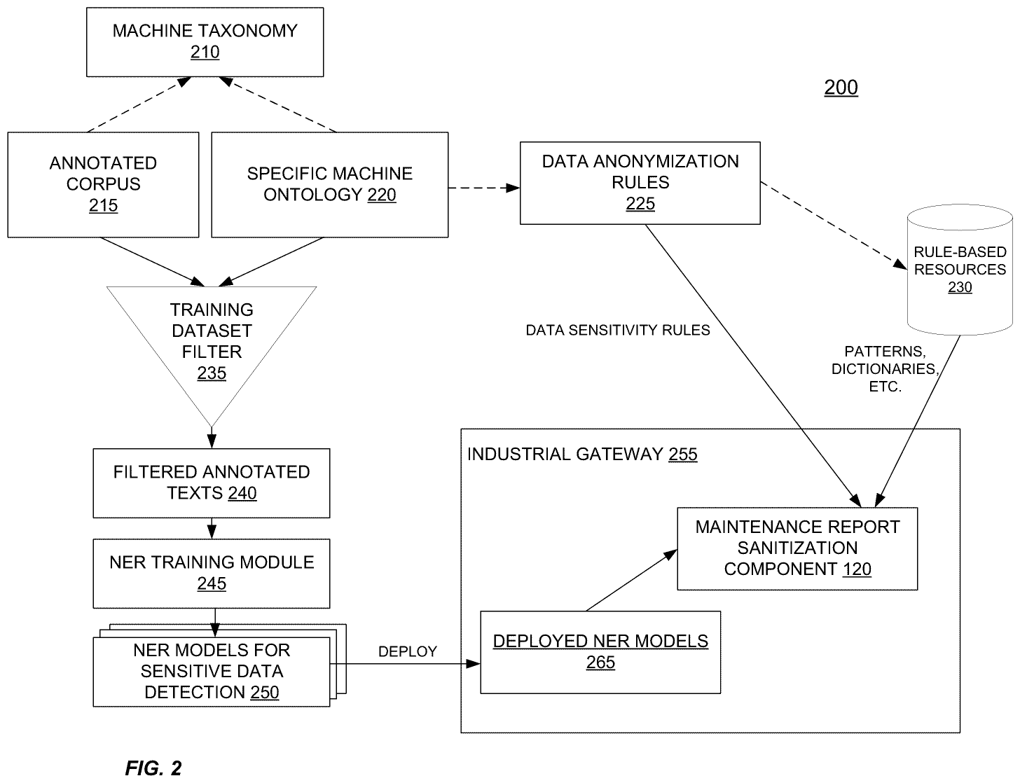

FIG. 2 is a block diagram illustrating a system for training and deploying a maintenance report sanitization component, according to one embodiment described herein. As shown, the system 200 includes an annotated corpus 215 (e.g., annotated maintenance report corpus 138) and a specific machine ontology 220 (e.g., one of the machine-specific ontologies 139) that relate to a machine taxonomy 210. Such a relationship is advantageous as, for example, references within the annotated corpus 215 can be directly mapped to elements within the specific machine ontology 220, and vise versa.

The maintenance report sanitization component 120 can process the annotated corpus 215 and the specific machine ontology 220 to generate the training dataset filter 235. The maintenance report sanitization component 120 can then process the maintenance reports within the annotated corpus to generate the filtered annotated texts 240. The filtered annotated texts 240 can then be used to train the NER training module 245 (e.g., NER model 118). In the depicted embodiment, the NER training module 245 is added to a collection of NER models for sensitive data detection 250, which are then deployed to an industrial gateway 255 as deployed NER models 265. Generally, the industrial gateway 255 represents one or more computer systems on which the deployed NER models 265 will be used for identifying and processing maintenance reports to sanitize the maintenance reports for sensitive data. For example, the maintenance report sanitization component 120 could generate a separate NER training module 245 for each product in a line of products, and could deploy all of the generated NER training modules 245 to the industrial gateway 255 for use in processing maintenance reports.

Additionally, a set of data anonymization rules 225 (e.g., data anonymization rules 132) are created, e.g., by one or more domain experts.

Similarly, the data anonymization rules 225 directly relate to one or more elements the specific machine ontology 220. Moreover, for at least one of the data anonymization rules 225, a corresponding at least one rule-based resources 230 can be created, e.g., by the one or more domain experts. As an example, a first data anonymization rule 225 could be configured for detecting site locations where the maintenance event described in the report occurs, and a rule-based resource 230 (e.g., a dictionary) could be created with an exhaustive list of current locations where the equipment that is the subject of the maintenance report is deployed. For example, a company may have 10 sites within the United States, but for a given piece of equipment, the equipment may only be deployed at 3 different sites. As such, a rule 225 could be created for detecting references to the site at which the equipment is deployed, and a corresponding rule-based resource 230 could be created for identifying the 3 sites at which the equipment is deployed. Doing so improves the efficiency and accuracy of the system by ensuring that references to unrelated locations are not detected or classified as constituting sensitive information.

Additionally, the rule-based resource 230 may include not just the proper name for a given location, but more generally can include any and all references to the location that are known to be used in maintenance reports. As an example, a site in Lexington, KY could be referred to formally as the “Lexington facility”, the “KY site”, “LEX”, and so on. Such an example of course is provided for illustrative purposes and without limitation, and more generally such a concept can be extended not just to sites and locations but more generally to any element within the specific machine ontology 220, consistent with the functionality described herein.

In the depicted system 200, the data anonymization rules 225 and their corresponding rule-based resources 230 can then be deployed to the industrial gateway 255 as part of the maintenance report sanitization component 120. The maintenance report sanitization component 120, once deployed, can utilize the deployed NER models 265 and the deployed data anonymization rules 225 and rule-based resources 230 to process maintenance reports to detect and sanitize sensitive information within the maintenance reports. The sanitized maintenance reports can then be added to a collection of maintenance reports determined not to contain sensitive information, and this collection can be designated as suitable for external release (e.g., for use in training one or more machine learning models).

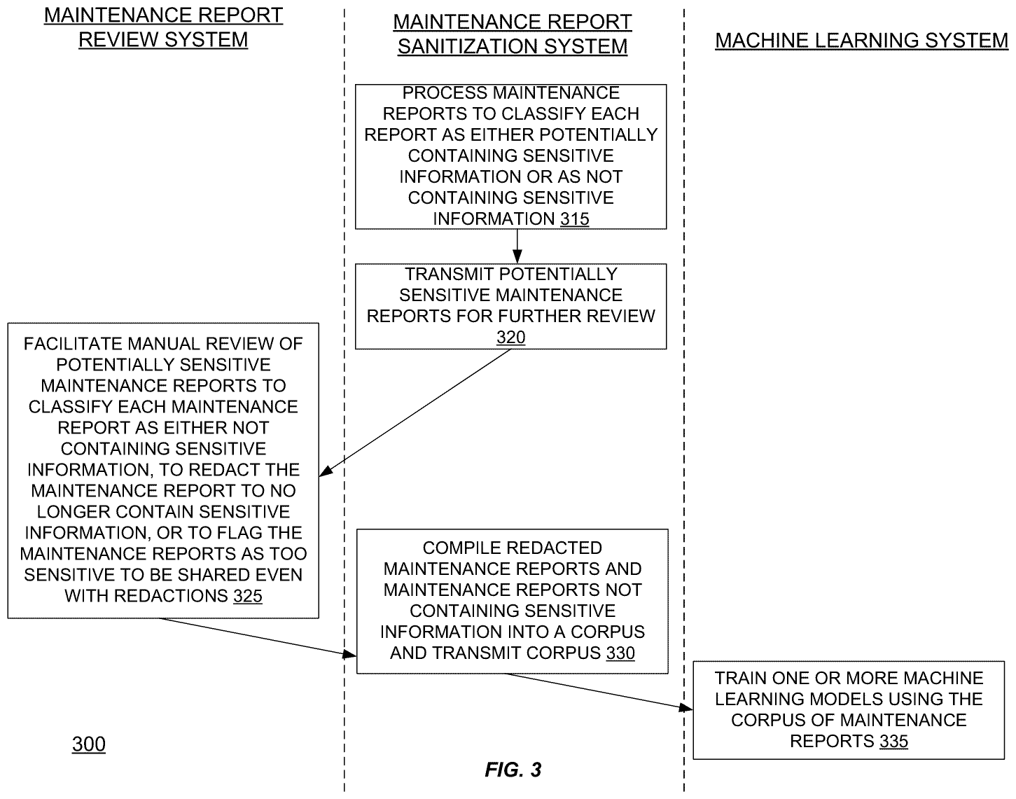

FIG. 3 is a flow diagram illustrating a method for processing maintenance reports to sanitize the maintenance reports for external release, according to one embodiment described herein. As shown, the method 300 begins at block 315, where the maintenance report sanitization component 120 processes maintenance reports to classify each report as either potentially containing sensitive information or as not containing sensitive information 315. As discussed above, for certain reports that are determined to contain sensitive information, the maintenance report sanitization component 120 could automatically perform one or more modifications to remove, alter or otherwise address the sensitive information within the report. For reports that the maintenance report sanitization component 120 determines cannot be automatically modified, these reports are transmitted to the maintenance report review system 300 for further review (block 320).

The maintenance report review system facilitates the manual review of potentially sensitive maintenance reports (block 325). In doing so, the maintenance report review system can classify the reports as not containing sensitive information (e.g., a false positive), can redact the maintenance report to no longer contain sensitive information (e.g., by replacing the sensitive text with corresponding generic text, by deleting the sensitive text entirely, etc.), or by flagging the report as too sensitive to be released. The maintenance report review system transmits the results of this review back to the maintenance report sanitization system, which then compiles the redacted maintenance reports together with the other maintenance reports not containing sensitive information into a corpus of sanitized maintenance reports (block 330). The corpus is then transmitted to an external machine learning system, which trains one or more machine learning models using the corpus of sanitized maintenance reports (block 335). For example, the machine learning system could collect sanitized maintenance reports from a number of different organizations and could train one or more machine learning models using the maintenance report documents.

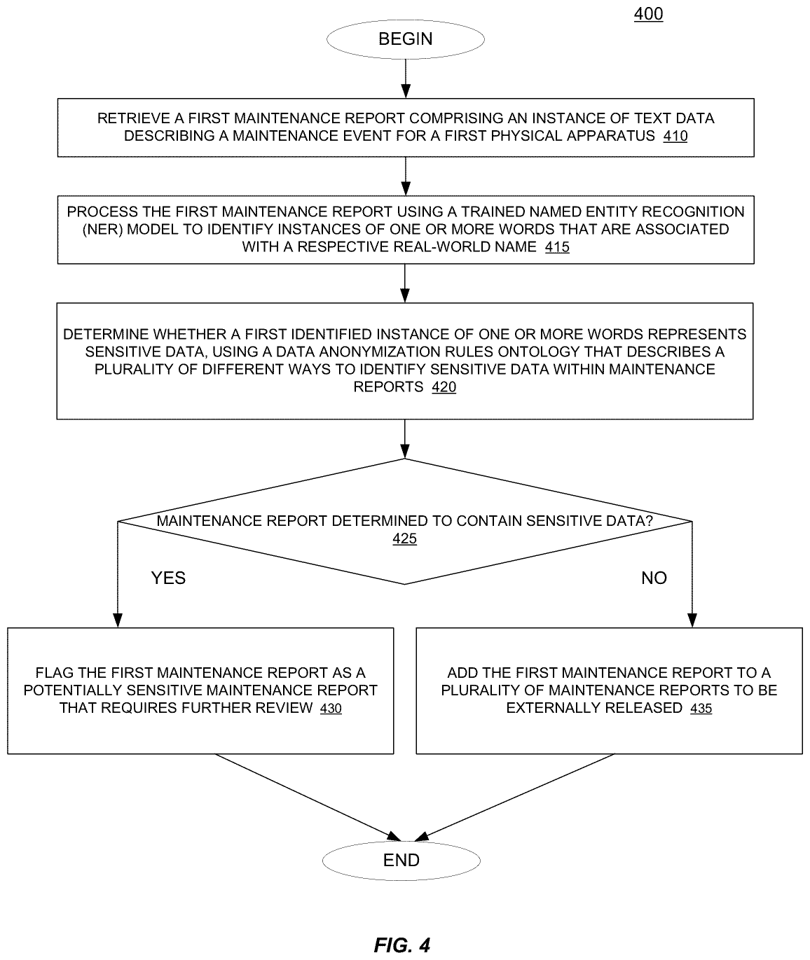

FIG. 4 is a flow diagram illustrating a method for processing maintenance reports to identify and manage any sensitive data contained within the maintenance reports, according to one embodiment described herein. As shown, the method 400 begins at block 410, where the maintenance report sanitization component 120 retrieves a first maintenance report comprising an instance of text data describing a maintenance event for a first physical apparatus. The maintenance report sanitization component 120 processes the first maintenance report using a trained NER model to identify instances of one or more words that are associated with a respective one or more real-world names (block 415). Additionally, the maintenance report sanitization component 120 determines whether a first identified instance of one or more words represents sensitive data, using a data anonymization rules ontology that describes a plurality of different ways to identify sensitive data within maintenance reports (block 420).

If the first maintenance report is determined to include sensitive data, the maintenance report sanitization component 120 flags the first maintenance report as a potentially sensitive maintenance report that requires further review (block 425). The maintenance report sanitization component 120 could then, for instance, facilitate a review and edit of the maintenance report by a maintenance technician. As an example, the maintenance report sanitization component 120 could provide a graphical user interface, showing the maintenance report and highlighting one or more words that were determined to constitute sensitive information. The maintenance report sanitization component 120 could further provide information describing a reason(s) the one or more words were determined to be sensitive. For instance, the maintenance report sanitization component 120 could show within the user interface one or more rules for use in identifying sensitive data that the one or more words satisfied, e.g., the graphical user interface could indicate that the one or more words were determined to constitute manufacturing data and thus were classified as potentially sensitive information.

The maintenance report sanitization component 120 could further provide a mechanism through which the maintenance technician could provide input through the graphical user interface. For instance, upon generating and outputting for display the graphical user interface illustrating one or more words highlighted within a maintenance report and determined to constitute sensitive information, the graphical user interface could provide a mechanism through which the maintenance technician can provide feedback regarding the potentially sensitive information. As an example, the maintenance technician could provide feedback through the graphical user interface, indicating that the potentially sensitive information was incorrectly identified as sensitive and that the report does not contain sensitive information. In such a case, the maintenance report sanitization component 120 could reclassify the maintenance report in question based on the received feedback and could add the raw maintenance report to a corpus of maintenance reports intended for public release. As another example, the maintenance technician could provide feedback indicating that the report cannot be edited to remove the sensitive information. In response to such feedback, the maintenance report sanitization component 120 could then flag the maintenance report as containing sensitive information and could add the maintenance report to a second corpus of maintenance reports that are unsuitable for public release.

As another example, the maintenance technician could provide one or more modifications (e.g., redactions) to the maintenance report via the user interface. The maintenance report sanitization component 120 could then modify the raw maintenance report based on the received modifications and could add the modified maintenance report to the corpus of maintenance reports intended for public release. As an example, such modifications could include the deletion of one or more words within the report (e.g., removing the words from the raw maintenance report altogether, applying a graphical object over top of the words so that the words can not longer be seen within the report, etc.), an edit to the one or more words within the report (e.g., the one or more words within the raw report could be replaced with a second one or more words received via the graphical user interface from the maintenance technician, where the second one or more words are deemed not to include sensitive data), and more generally any suitable modification to the maintenance report to remove the sensitive information. For instance, the maintenance report sanitization component 120 could receive the input from the maintenance technician via the graphical user interface and, in response, could delete one or more words determined to constitute sensitive information from the raw maintenance report and could add the modified maintenance report to the corpus of maintenance reports suitable for public release.

If the maintenance report sanitization component 120 determines that the first maintenance report does not include any sensitive data, the maintenance report sanitization component 120 could add the first maintenance report to a plurality of maintenance reports to be externally released (block 435). Once the maintenance report sanitization component 120 has added the maintenance report to the plurality of maintenance reports intended and suitable for public release (either at block 430 or block 435), the method 400 ends. Advantageously, the method 400 enables the efficient processing of a large quantity of maintenance reports to identify the set of reports potentially containing sensitive information and enables maintenance technicians and other suitable users to efficiently review and redact reports containing sensitive information to generate a corpus of maintenance reports that are suitable for public release (i.e., that do not contain sensitive information).

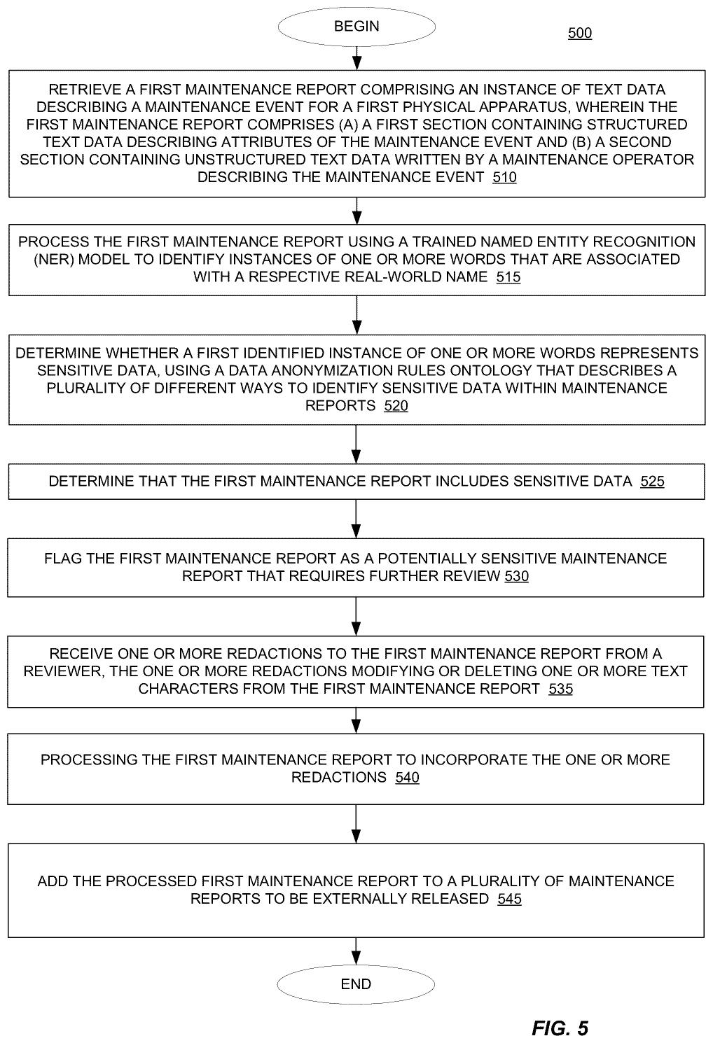

FIG. 5 is a flow diagram illustrating a method for processing a maintenance report to be included in a corpus of maintenance reports intended for public release. As shown, the method 500 begins at block 510, where the maintenance report sanitization component 120 retrieves a first maintenance report comprising an instance of text data describing a maintenance event for a first physical apparatus. In the depicted embodiment, the first maintenance report comprises (a) a first section containing structured text data describing attributes of the maintenance event and (b) a second section containing unstructured text data written by a maintenance operator describing the maintenance event. For example, the first section could include various fields to be completed with metadata pertaining to the maintenance event, such as the model number of equipment involved, the time and date on which the maintenance event occurred, the location of the equipment involved, a severity of the maintenance event, and so on. More generally, any structured text data describing attributes of the maintenance event can be included, consistent with the functionality described herein. The second section could contain a narrative written by the maintenance technician, describing the maintenance event. Such a narrative could include, without limitation, a description of what occurred during the maintenance event, a suspected cause(s) of the maintenance event, an action(s) taken to remediate the equipment as a result of the maintenance event, and so on.

The maintenance report sanitization component 120 then processes the first maintenance report using a trained NER model to identify instances of one or more words that are associated with a respective real-world name (block 515). The maintenance report sanitization component 120 determines whether a first identified instance of one or more words represents sensitive data, using a data anonymization rules ontology that describes a plurality of different ways to identify sensitive data within maintenance reports (block 520). In doing so, the maintenance report sanitization component 120 could identify one or more text portions within the first maintenance report that correspond to one or more machine components and could further determine, for each of the one or more machine components, whether the respective machine component is classified as a sensitive machine component, using the trained NER model, one or more data sensitivity rules, and one or more rule-based resources.

Upon determining that the first maintenance report includes sensitive data (block 525), the maintenance report sanitization component 120 flags the first maintenance report as a potentially sensitive maintenance report that requires further review (block 530). Additionally, the maintenance report sanitization component 120 receives one or more redactions to the first maintenance report from a reviewer, the one or more redactions modifying or deleting one or more text characters from the first maintenance report (block 535). The maintenance report sanitization component 120 processes the first maintenance report to incorporate the one or more redactions (block 540). Once the redactions are processed, the maintenance report is deemed to be sanitized and so the maintenance report sanitization component 120 adds the processed first maintenance report to a plurality of maintenance reports to be externally released (block 545), and the method 500 ends.

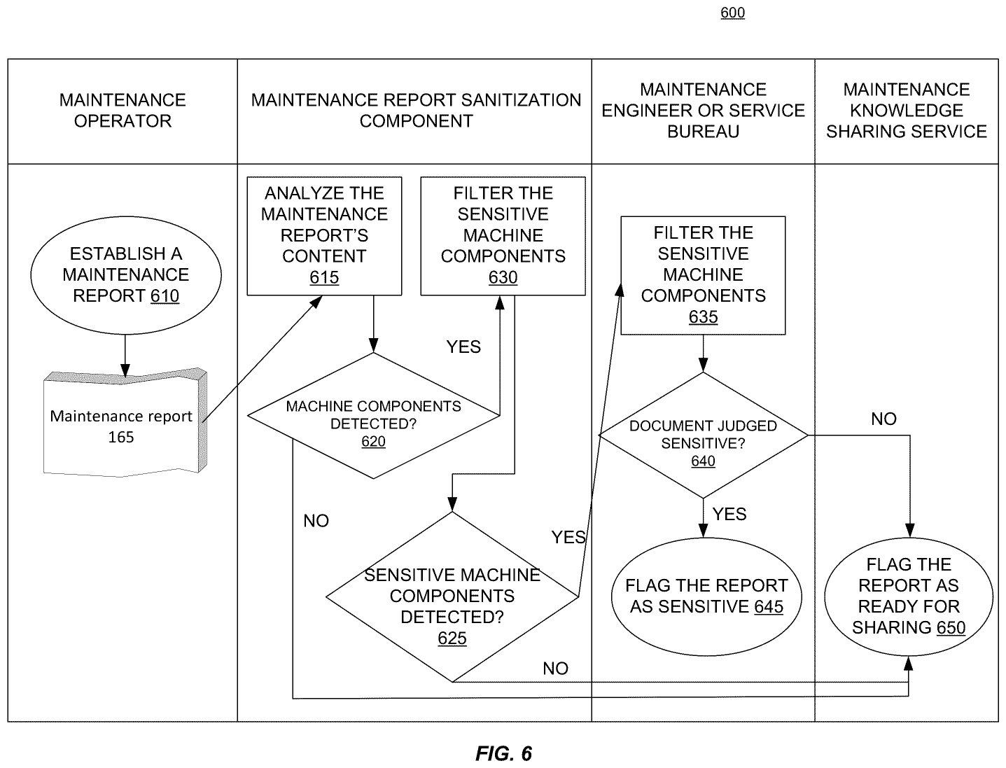

FIG. 6 is a flow diagram illustrating a workflow for processing maintenance reports to identify sensitive reports, according to one embodiment described herein. As shown, the workflow 600 begins at block 610, where a maintenance operator establishes a maintenance report 165. Such a report could be an electronic document (e.g., created using a word processing application, submitted using a web form, or more generally created using any other suitable software application(s)) or could be a physical document. In the latter case where the maintenance report 165 constitutes a physical document, an electronic document can be created by scanning the physical document using a suitable device(s) and by applying one or more processes (e.g., an OCR process) to the scanned image to generate an electronic document. More generally, it is contemplated that the maintenance report 165 can be created in any number of different ways, consistent with the functionality described herein.

The maintenance report sanitization component 120 analyzes the maintenance report's contents (block 615) and determines whether any references to machine components are detected within the report (block 620). If not, the maintenance report sanitization component 120 flags the report for sharing (block 650). If the maintenance report sanitization component 120 detects one or more references to machine components within the report, the maintenance report sanitization component 120 applies a filter to the detected machine components to identify any potentially sensitive machine components (block 630) and then determines whether any potentially sensitive machine components are detected (block 625). If not, the maintenance report sanitization component 120 flags the report as ready for sharing (block 650).

If one or more references to sensitive machine components are detected, a maintenance engineer or service bureau filters the detected references (block 635) and determines whether the document as a whole should be judged sensitive (block 640). If so, the report is flag as sensitive and not suitable for external release (block 645), while if the document is determined to not be judged as sensitive, the report is flagged as ready for sharing (block 650).

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A computer-implemented method, comprising:
retrieving a first maintenance report comprising an instance of text data describing a maintenance event for a first physical apparatus;
processing, by operation of one or more computer processors, the first maintenance report using a trained Named Entity Recognition (NER) model to identify instances of one or more words that are associated with a respective one or more real-world names;
determining whether a first identified instance of one or more words represents sensitive data, using a data anonymization rules ontology that describes a plurality of different ways to identify sensitive data within maintenance reports;
if the first maintenance report is determined to include sensitive data:
determining whether the first maintenance report can be automatically modified with a first modification, such that the modified first maintenance report does not include any sensitive data, using on the data anonymization rules ontology;
if so, performing, by operation of the one or more computer processors, the first modification on the first maintenance report and adding the modified first maintenance report to a plurality of maintenance reports to be externally released;
if not, flagging the first maintenance report as a potentially sensitive maintenance report that requires further review; and
if the first maintenance report is determined to not include any sensitive data, adding the first maintenance report to the plurality of maintenance reports to be externally released.

2. The computer-implemented method of claim 1, wherein the first maintenance report comprises (a) a first section containing structured text data describing attributes of the maintenance event and (b) a second section containing unstructured text data written by a maintenance operator describing details of the maintenance event.

3. The computer-implemented method of claim 1, further comprising:
prior to processing the first maintenance report, training the NER model using a plurality of annotated maintenance reports, wherein each of the plurality of annotated maintenance reports comprises (a) a first section containing structured text data describing attributes of a maintenance event and (b) a second section containing unstructured text data written by a maintenance operator describing details of the maintenance event, and wherein the plurality of annotated maintenance reports are annotated to contain a plurality of text entries, each corresponding to a portion of text in either the first section or the second section and associated with a respective one or more tagged machine components.

4. The computer-implemented method of claim 3, wherein training the NER model further uses one or more specific machine ontologies that describes a physical machine and a plurality of components of the physical machine, wherein the one or more tagged machine components associated with the plurality of text entries each correspond to a respective concept within the one or more specific machine ontologies.

5. The computer-implemented method of claim 3, further comprising:
responsive to flagging the first maintenance report as a potentially sensitive maintenance report that requires further review, receiving user feedback specifying whether the first maintenance report contains sensitive information; and
updating the data anonymization rules ontology based on the received user feedback, wherein one or more weights within the data anonymization rules ontology are modified to reinforce the determination that the first identified instance of the one or more words represents sensitive data if the user feedback indicates that the determination was correct, and wherein the one or more weights within the data anonymization rules ontology are modified to weaken the determination that the first identified instance of the one or more words represents sensitive data if the user feedback indicates that the determination was incorrect.

6. The computer-implemented method of claim 1, wherein determining whether the first identified instance of one or more words represents sensitive data further comprises:
identifying one or more text portions within the first maintenance report that correspond to one or more machine components; and
determining, for each of the one or more machine components, whether the respective machine component is classified as a sensitive machine component, using the trained NER model, one or more data sensitivity rules, and one or more rule-based resources, wherein the one or more rule-based resources comprise at least one of a rule-based dictionary structure and a rule-based pattern.

7. The computer-implemented method of claim 1, wherein the sensitive data comprises at least one of:
personal data relating to a specific person,
business data describing information about a particular business or a customer, partner or subcontractor of the particular business,
manufacturing data describing information about a manufacturing process or machine components or configurations involved in the manufacturing process, and
other data deemed sensitive by a business entity.

8. The computer-implemented method of claim 1, wherein the plurality of maintenance reports to be externally released are used as at least part of a training data set for one or more machine learning models.

9. The computer-implemented method of claim 1, wherein upon flagging the first maintenance report as a potentially sensitive maintenance report that requires further review:
receiving one or more redactions to the first maintenance report from a reviewer, the one or more redactions modifying or deleting one or more text characters from the first maintenance report;
processing the first maintenance report to incorporate the one or more redactions; and
adding the processed first maintenance report to a plurality of maintenance reports to be externally released.

10. A system, comprising:
one or more computer processors; and
a memory containing computer program code that, when executed by operation of the one or more computer processors, performs an operation comprising:
retrieving a first maintenance report comprising an instance of text data describing a maintenance event for a first physical apparatus;
processing the first maintenance report using a trained Named Entity Recognition (NER) model to identify instances of one or more words that are associated with a respective one or more real-world names;
determining whether a first identified instance of one or more words represents sensitive data, using a data anonymization rules ontology that describes a plurality of different ways to identify sensitive data within maintenance reports;
if the first maintenance report is determined to include sensitive data, flagging the first maintenance report as a potentially sensitive maintenance report that requires further review; and
if the first maintenance report is determined to not include any sensitive data, adding the first maintenance report to a plurality of maintenance reports to be externally released.

11. The system of claim 10, wherein the first maintenance report comprises (a) a first section containing structured text data describing attributes of the maintenance event and (b) a second section containing unstructured text data written by a maintenance operator describing details of the maintenance event.

12. The system of claim 10, the operation further comprising:
prior to processing the first maintenance report, training the NER model using a plurality of annotated maintenance reports, wherein each of the plurality of annotated maintenance reports comprises (a) a first section containing structured text data describing attributes of a maintenance event and (b) a second section containing unstructured text data written by a maintenance operator describing details of the maintenance event, and wherein the plurality of annotated maintenance reports are annotated to contain a plurality of text entries, each corresponding to a portion of text in either the first section or the second section and associated with a respective one or more tagged machine components.

13. The system of claim 12, wherein training the NER model further uses one or more specific machine ontologies that describes a physical machine and a plurality of components of the physical machine, wherein the one or more tagged machine components associated with the plurality of text entries each correspond to a respective concept within the one or more specific machine ontologies.

14. The system of claim 10, wherein determining whether the first identified instance of one or more words represents sensitive data further comprises:
identifying one or more text portions within the first maintenance report that correspond to one or more machine components; and
determining, for each of the one or more machine components, whether the respective machine component is classified as a sensitive machine component, using the trained NER model, one or more data sensitivity rules, and one or more rule-based resources.

15. The system of claim 14, wherein the one or more rule-based resources comprise at least one of a rule-based dictionary structure and a rule-based pattern.

16. The system of claim 10, wherein the sensitive data comprises at least one of:
personal data relating to a specific person,
business data describing information about a particular business or a customer, partner or subcontractor of the particular business,
manufacturing data describing information about a manufacturing process or machine components or configurations involved in the manufacturing process, and
other data deemed sensitive by a business entity.

17. The system of claim 10, wherein the plurality of maintenance reports to be externally released are used as at least part of a training data set for one or more machine learning models.

18. The system of claim 10, wherein upon flagging the first maintenance report as a potentially sensitive maintenance report that requires further review:
receiving one or more redactions to the first maintenance report from a reviewer, the one or more redactions modifying or deleting one or more text characters from the first maintenance report;
processing the first maintenance report to incorporate the one or more redactions; and
adding the processed first maintenance report to a plurality of maintenance reports to be externally released.

19. A non-transitory computer-readable medium containing computer program code that, when executed by operation of one or more computer processors, performs an operation comprising:
retrieving a first maintenance report comprising an instance of text data describing a maintenance event for a first physical apparatus, wherein the first maintenance report comprises (a) a first section containing structured text data describing attributes of the maintenance event and (b) a second section containing unstructured text data written by a maintenance operator describing details of the maintenance event;
processing the first maintenance report using a trained Named Entity Recognition (NER) model to identify instances of one or more words that correspond to one or more machine components;
determining whether a first identified instance of one or more words represents sensitive data, using a data anonymization rules ontology that describes a plurality of different ways to identify sensitive data within maintenance reports, comprising:
determining, for each of the one or more machine components, whether the respective machine component is classified as a sensitive machine component, using one or more data sensitivity rules and one or more rule-based resources;
upon determining that the first maintenance report includes sensitive data:
flagging the first maintenance report as a potentially sensitive maintenance report that requires further review;
receiving one or more redactions to the first maintenance report from a reviewer, the one or more redactions modifying or deleting one or more text characters from the first maintenance report;
processing the first maintenance report to incorporate the one or more redactions; and
adding the processed first maintenance report to a plurality of maintenance reports to be externally released.

20. The non-transitory computer-readable medium of claim 19, the operation further comprising:
prior to processing the first maintenance report, training the NER model using a plurality of annotated maintenance reports, wherein each of the plurality of annotated maintenance reports comprises (a) a first section containing structured text data describing attributes of a maintenance event and (b) a second section containing unstructured text data written by a maintenance operator describing the maintenance event, and wherein the plurality of annotated maintenance reports are annotated to contain a plurality of text entries, each corresponding to a portion of text in either the first section or the second section and associated with a respective one or more tagged machine components,
wherein training the NER model further uses one or more specific machine ontologies that describes a physical machine and a plurality of components of the physical machine, wherein the one or more tagged machine components associated with the plurality of text entries each correspond to a respective concept within the one or more specific machine ontologies.
